(19) United States
(12) Patent Application Publication
(10) Pub. No.: US 2011/0141612 A1
(43) Pub. Date: Jun. 16, 2011

(54) METHOD OF UNLOADING TRANSDUCER IN DATA STORAGE DEVICE AND DISK DRIVE AND STORAGE MEDIUM USING THE METHOD

(75) Inventors: Kyoung-whan Oh, Seoul (KR); Sang-ho Lee, Seoul (KR); Ji-won Ha, Daegu (KR); Bong-lin Lee, Tongyeong-si (KR)

(73) Assignee: Samsung Electronics Co., Ltd, Suwon-si (KR)

(21) Appl. No.: 12/870,944

(22) Filed: Aug. 30, 2010

(30) Foreign Application Priority Data
Dec. 15, 2009 (KR) 2009-125039

(51) Int. Cl. G11B 21/02

(52) U.S. Cl. 360/75; G9B/21.003

(57) ABSTRACT

Provided are a method and apparatus for performing optimum transducer unloading in a data storage device according to circumstances. The method of unloading a transducer in a data storage device comprises: determining whether a condition that requires an unloading operation is detected while the transducer is positioned on a data area on a disk; selecting, when the condition that requires the unloading operation is detected, an unloading mode corresponding to the detected condition from among a plurality of unloading modes; and moving the transducer to an area other than the data area on the disk according to the selected unloading mode.

### CROSS-REFERENCE TO RELATED APPLICATIONS

This application claims the benefit of Korean Patent Application No. 10-2009-0125039, filed on Dec. 15, 2009, in the Korean Intellectual Property Office, the disclosure of which is incorporated herein in its entirety by reference.

### BACKGROUND

1. Field of the Invention

The inventive concept relates to a method and apparatus for unloading a transducer in a data storage device, and more particularly, to a method and apparatus for performing an optimum unloading operation of a transducer according to conditions in a data storage device.

2. Description of the Related Art

disk drive, which is a type of data storage device, connects to a host device to write data to a recording medium or read the data written to the recording medium according to a command of the host device. In order to read or write data, the disk drive performs a loading mode in which a transducer is moved onto a data area of a disk, and performs an unloading operation during an unloading mode in which the transducer is transported out of the data area on the disk under non-operational conditions or in an abnormal operational state.

Thus, research into a method of stably and quickly executing loading and unloading during a loading mode and an unloading mode according to disk drive conditions needs to be conducted.

### SUMMARY

The inventive concept provides a method of optimally unloading a transducer according to operational conditions in a disk drive.

The inventive concept also provides a data storage device that performs an optimum unloading operation of a transducer according to an operational condition in a disk drive.

The inventive concept also provides a storage medium having embodied thereon a program code for executing a method of executing an optimum unloading operation of a transducer according to an operational condition in a disk drive.

According to an aspect of the inventive concept, there is provided a method of unloading a transducer in a data storage device, the method comprising: determining whether a condition that requires an unloading operation while a transducer is positioned on a data area on a disk is detected; selecting, when the condition that requires the unloading operation is detected, an unloading mode corresponding to the detected condition from among a plurality of unloading modes; and moving the transducer to an area other than the data area on the disk according to the selected unloading method.

The plurality of unloading modes may include a ramp unloading mode in which the transducer is parked at the ramp parking unit and a disk inner unloading mode in which the transducer is parked in an inner circumferential area of the disk.

In the disk inner unloading mode, an actuator arm in which the transducer is mounted may be controlled to be fixed to an inner circumference crash stop rubber to park the transducer in an inner circumferential area of the disk.

In the selecting of an unloading mode, a disk inner unloading mode of parking the transducer in the inner circumferential area of the disk may be selected when a condition that requires an unloading operation is detected based on an alarm state that indicates that the data storage device cannot normally operate, and a ramp unloading mode of parking the transducer in the ramp parking unit may be selected when other unloading operations are required.

The alarm state may be determined when a disturbance sensed by the data storage device exceeds a critical value or when a servo signal written to the disk is not normally read.

The ramp unloading mode may be selected under a condition when the disk drive transitions from a power on mode to a power off mode or to a power save mode.

When the disk inner unloading mode is selected from among the plurality of unloading modes, an actuator arm, to which the transducer is attached, may be moved to the inner circumference crash stop rubber, and then a predetermined force may be applied to the actuator arm toward the inner circumference crash stop rubber.

When the selected unloading mode is a disk inner unloading mode based on an alarm state, the method may further comprise initializing parameters of the data storage device and moving the transducer to the data area on the disk after moving the transducer toward the inner circumference so that the transducer is parked in the inner circumferential area other than the data area of the disk.

The initializing of the parameters may comprise calibration of an instrumental/electrical unit with respect to channel parameters of the data storage device.

The moving the transducer may comprise controlling a movement speed of the transducer using a back electromotive force.

According to another aspect of the inventive concept, there is provided a disk drive comprising: a disk storing data; a transducer that writes to the disk or reads data from the disk; a voice coil motor (VCM) moving the transducer; and a controller that selects, when a condition that requires an unloading operation is detected while the transducer is positioned in a data area on the disk, an unloading mode corresponding to the detected condition, from among a plurality of unloading modes and controls a current supplied to the VCM so as to execute an unloading process.

The controller may detect a movement speed of the transducer by using a back electromotive force that is generated in the VCM in a loading operation or an unloading operation, and control a current supplied to the VCM such that the detected movement speed of the transducer reaches a target speed.

The controller may control a current supplied to the VCM such that an actuator arm, to which the transducer is mounted, is fixed to an inner circumference crash stop rubber installed in a head disk assembly, when a disk inner unloading mode is selected from among a plurality of unloading modes.

The controller may execute a disk inner unloading mode for parking the transducer in an inner circumferential area of the disk when a condition that requires an unloading operation is detected based on an alarm state that indicates that the disk drive cannot normally operate, and control a current supplied to the VCM so as to execute a ramp unloading mode for parking the transducer in the ramp parking unit under other conditions that require an unloading operation.

When a shock amount sensed by the data storage device exceeds a critical value or a servo signal written to the disk cannot be normally read, the controller may determine that the alarm state is generated.

The controller may control initializing of channel parameters and performing of calibration of an instrumental/electrical unit after executing an unloading process by selecting a disk inner unloading mode based on a generated alarm state.

After initializing the channel parameters and performing calibration of an instrumental/electrical unit, the controller may control a current supplied to the VCM so as to move the transducer to a data area on the disk.

After performing a disk inner unloading process the controller may supply a current for moving the transducer toward an inner circumference of the disk for a predetermined period of time to the VCM at a timing for executing a loading process, and the controller may supply a current for moving the transducer toward an outer circumference of the disk to thereby move the transducer to the data area on the disk.

According to another aspect of the inventive concept, there is provided a computer readable storage medium having embodied thereon a program code for executing the above-described method of unloading a transducer in a data storage device.

### BRIEF DESCRIPTION OF THE DRAWINGS

Exemplary embodiments of the inventive concept will be more clearly understood from the following detailed description taken in conjunction with the accompanying drawings in which:

FIG. 1 is a structural diagram illustrating a data storage device according to an embodiment of the inventive concept;

FIG. 2 illustrates an operation system of software of the data storage device of FIG. 1;

FIG. 3 is a plan view illustrating a head disk assembly of a disk drive, according to another embodiment of the inventive concept;

FIG. 4 is an electrical structural diagram illustrating a disk drive according to another embodiment of the inventive concept;

FIG. 5 illustrates a detailed structure of a ramp parking unit illustrated in FIG. 1;

FIG. 6 is a detailed circuit diagram of a back electromotive force measuring unit illustrated in FIG. 4;

FIG. 7 is a structural diagram illustrating a transducer unloading operation processing device according to an embodiment of the inventive concept;

FIG. 8 is a schematic view of a sector structure of a track of a disk, which is a recording medium applied to the inventive concept;

FIG. 9 illustrates a structure of a servo information area illustrated in FIG. 8;

FIG. 10 illustrates a current waveform supplied to a voice coil motor in an unloading operation when a ramp unloading mode according to the inventive concept is applied;

FIG. 11 illustrates a current waveform supplied to a voice coil motor in a loading operation when a ramp unloading mode according to the inventive concept is applied;

FIG. 12 illustrates a current waveform supplied to a voice coil motor in an unloading operation when a disk inner unloading mode according to the inventive concept is applied;

FIG. 13 illustrates a current waveform supplied to a voice coil motor in a loading operation when the disk inner unloading mode according to the inventive concept is applied;

FIG. 14 is a flowchart illustrating a transducer unloading method in a data storage device according to an embodiment of the inventive concept; and

FIG. 15 is a flowchart illustrating a transducer unloading method in a data storage device according to another embodiment of the inventive concept.

### DETAILED DESCRIPTION OF THE EMBODIMENTS

The inventive concept will now be described more fully with reference to the accompanying drawings, in which exemplary embodiments of the inventive concept are shown. The inventive concept may, however, be embodied in many different forms and should not be construed as being limited to the embodiments set forth herein; rather, these embodiments are provided so that this disclosure will be thorough and complete, and will fully convey the concept of the inventive concept to those of ordinary skill in the art. Like reference numerals in the drawings denote like elements, and thus their description will be omitted.

The inventive concept will now be described more fully with reference to the accompanying drawings, in which exemplary embodiments of the inventive concept are shown.

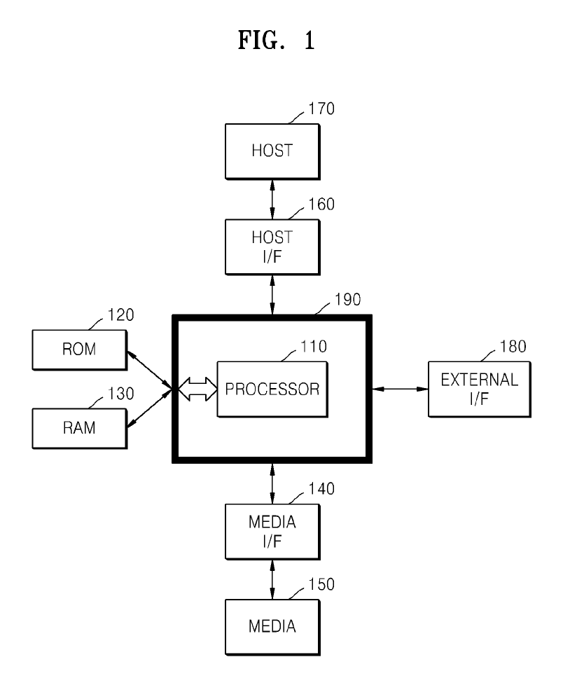

FIG. 1 is a structural diagram illustrating a data storage device according to an embodiment of the inventive concept. Referring to FIG. 1, the data storage device includes a processor 110, a read only memory (ROM) 120, a random access memory (RAM) 130, a media interface (MEDIA I/F) 140, a media (MEDIA) 150, a host interface (HOST I/F) 160, a host device (HOST) 170, an external interface (EXTERANL I/F) 180, and a bus (BUS) 190.

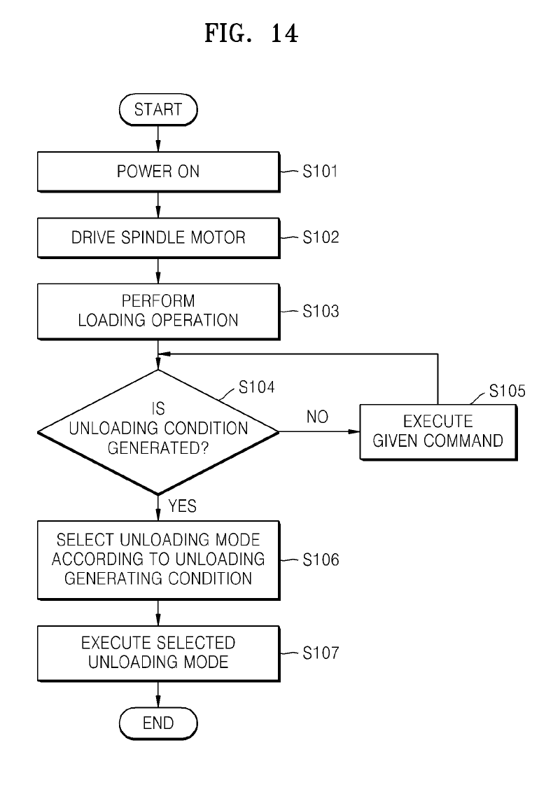

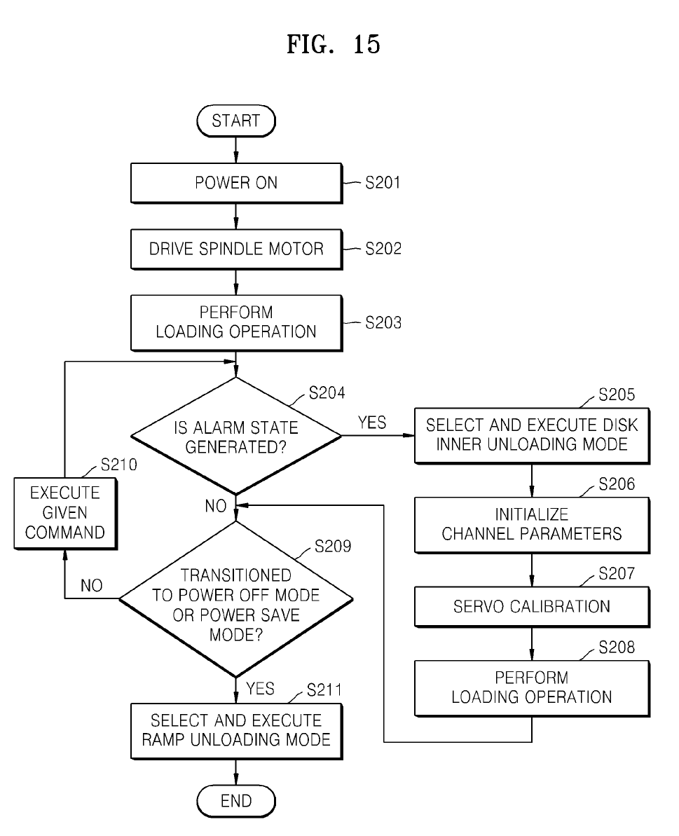

The processor 110 interprets a command and controls elements of the data storage device according to a result of the interpretation. The processor 110 includes a code object management unit, and loads a code object stored in the media 150 in the RAM 130 by using the code object management unit. In detail, the processor 110 loads code objects for executing methods of unloading a transducer in a data storage device according to flowcharts illustrated in FIGS. 14 and 15 to the RAM 130.

Then, the processor 110 executes a task of selecting and performing an optimum unloading operation of a transducer if a condition that requires a transducer unloading operation is detected according to the flowcharts of FIGS. 14 and 15 by using the code objects loaded in the RAM 130, and stores data that is needed to load or unload a transducer, in the media 150 or the ROM 120. An example of information needed to execute a transducer loading or unloading process may be a critical value used for determining an alarm state.

The method of unloading a transducer in a data storage device by using the processor 110 will be described in detail with reference to FIGS. 14 and 15 below.

In the ROM 120, program codes and data needed to operate the data storage device are stored.

The program codes and data stored in the ROM 120 or the media 150 are loaded to the RAM 130 according to control by the processor 110.

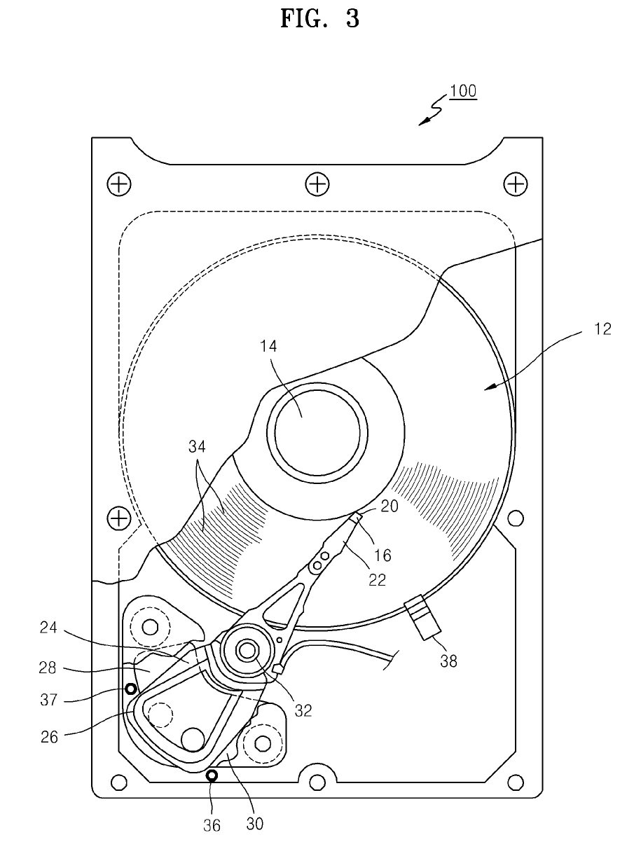

The media 150 may include a disk as a main storage medium of the data storage device. The data storage device may include a disk drive, and a detailed structure of a head disk assembly in which the disk is included in the disk drive is illustrated in FIG. 3.

FIG. 3 is a plan view illustrating a head disk assembly 100 of a disk drive according to another embodiment of the inventive concept. Referring to FIG. 3, the head disk assembly 100 includes at least one disk 12 that is rotated by a spindle motor 14. The disk drive also includes a transducer 16 that is adjacent to a surface of the disk 12.

The transducer 16 senses a magnetic field of the disk 12 or magnetizes the disk 12 to read or write information from/to the disk 12 that is being rotated. In general, the transducer 16 is associated with a surface of the disk 12. Although one transducer 16 is illustrated in FIG. 3, the transducer 16 needs to be regarded as comprising a writing transducer for magnetizing the disk 12 and a reading transducer for sensing a magnetic field of the disk 12. The reading transducer may be a magneto-resistive (MR) device. The transducer 16 is usually referred to as a magnetic head or a head.

The transducer 16 may be integrated with a slider 20. The slider 20 generates an air bearing between surfaces of the transducer 16 and the disk 12. The slider 20 is coupled to a head gimbal assembly 22. The head gimbal assembly 22 is attached to an actuator arm 24 having a voice coil 26. The voice coil 26 is disposed adjacent to a magnetic assembly 28 to define a voice coil motor (VCM) 30. A current supplied to the voice coil 26 generates torque for rotating the actuator arm 24 with respect to the bearing assembly 32. Due to the rotation of the actuator arm 24, the transducer 16 is moved across the surface of the disk 12.

The head disk assembly 100 may have a crash stop system to limit a range that the transducer 16 may move. In detail, the crash stop system includes an inner circumference crash stop rubber 36 that limits a maximum allowable position that the transducer 16 may move toward of an inner circumference of the disk 12 and an outer circumference crash stop rubber 37 that limits a maximum allowable position that the transducer 16 may move toward of an outer circumference of the disk 12. The positions of the inner circumference crash stop rubber 36 and the outer circumference crash rubber 37 are determined so as to ensure that the transducer 16 is moved to a predetermined position outside the data area of the disk 12. When the transducer 16 reaches the maximum allowable position toward the inner circumference of the disk 12, the actuator arm 24, to which the transducer 16 is attached, contacts the inner circumference crash stop rubber 36. Accordingly, the transducer 16 cannot move toward the inner circumference of the disk 12 any more. In the same manner, when the transducer 16 reaches the maximum allowable position toward the outer circumference of the disk 12, the actuator arm 24, to which the transducer 16 is attached, contacts the outer circumference crash stop rubber 37. Thus, the transducer 16 cannot move toward the outer circumference of the disk 12 any more.

In a disk drive, a loading mode is a mode in which the transducer 16 is transported from a parking area disposed outside the data area of the disk 12 to the disk area of the disk 12, and an unloading mode is a mode in which the transducer 16 is transported from the data area of the disk 12 to the parking area disposed outside the data area of the disk 12.

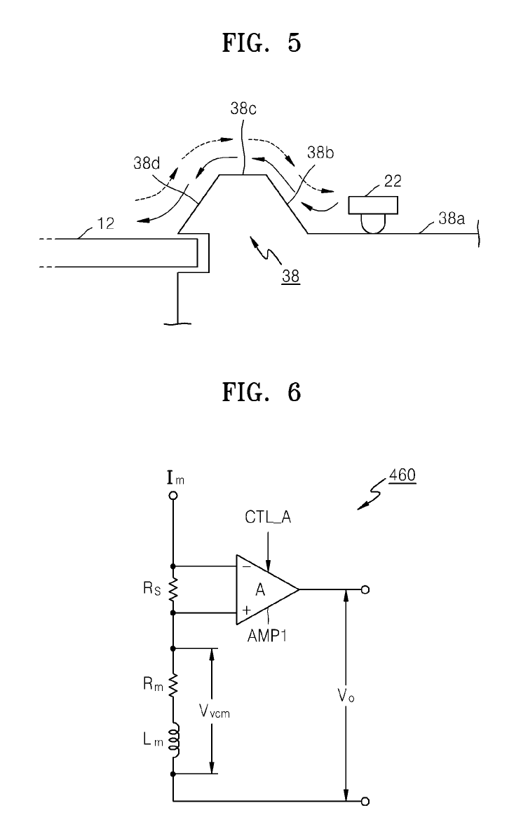

The head disk assembly 100 may include a ramp parking unit 38 that parks the transducer 16 out of the data area of the disk 12 in a power off mode or a power save mode of the disk drive. The ramp parking unit 38 is positioned in an outer circumferential area outside the data area. FIG. 5 illustrates a detailed structure of the ramp parking unit 38.

As illustrated in FIG. 5, the ramp parking unit 38 has inclined surfaces 38b and 38d and planar surfaces 38a and 38c.

A ramp loading/unloading method will be described with reference to FIG. 5. Referring to FIG. 5, a dotted arrow direction is an unloading direction of the transducer 16, and a solid arrow direction is a loading direction of the transducer 16.

First, in the unloading mode, the head gimbal assembly 22, to which the transducer 16 is attached, moves from the data area of the disk 12 in the dotted arrow direction according to rotation of the actuator arm 24, and finally contacts a parking surface 6d of the ramp parking unit 38. Referring to FIG. 3, when the head gimbal assembly 22 is positioned on the parking surface 6d of the ramp parking unit 38, the actuator arm 24 contacts the outer circumference crash stop rubber 37.

Next, in the loading mode, the head gimbal assembly 22, to which the transducer 16 is attached, is moved from the parking surface 6d of the ramp parking unit 38 in the solid arrow direction according to rotation of the actuator arm 24, and is finally positioned in the data area of the disk 12.

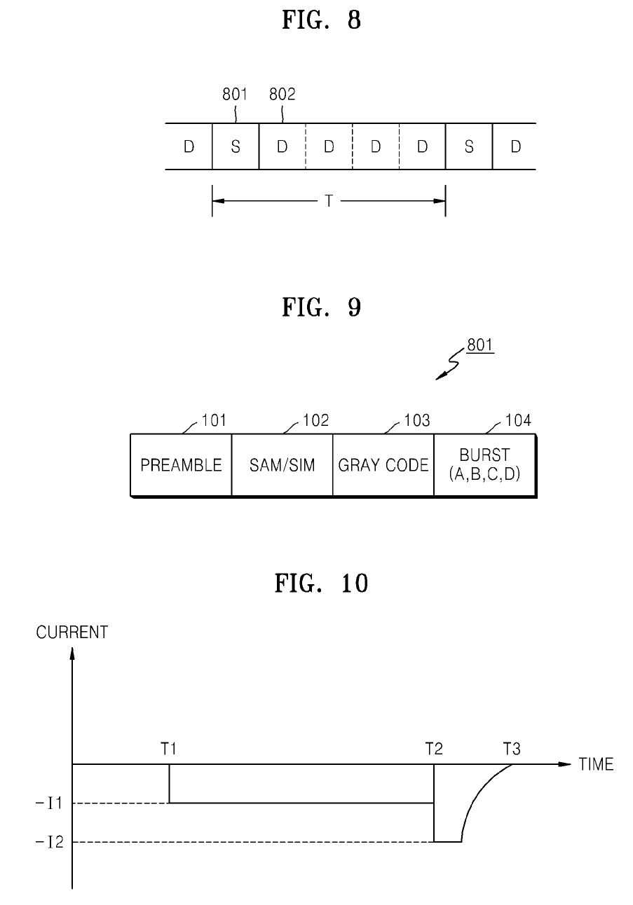

Referring to FIG. 3 again, data is usually stored in circular tracks 34 of the disk 12. Each of the tracks 34 usually includes a plurality of sectors. FIG. 8 illustrates a sector configuration of a track.

As illustrated in FIG. 8, one sector T includes a servo information field 801 and a data field 802, and the data field 802 may include a plurality of data blocks D. Also, the data field 802 may be a single data block D. Also, signals as illustrated in FIG. 9 are recorded to the servo information field 801.

As illustrated in FIG. 9, a preamble 101, a servo synchronization indication signal 102, a gray code 103, and a burst signal 104 are written to the servo information field 801.

The preamble 101 provides clock synchronization when reading servo data, and provides a predetermined timing margin by setting a gap before the servo sector. Also, the preamble 101 is used in determining a gain of an automatic gain control (AGC).

The servo synchronization indication signal 102 consists of a servo address mark (SAM) and a servo index mark (SIM). The servo address mark is a signal that indicates a start of a sector, and a servo index mark is a signal that indicates a start of a first sector in a track.

The gray code 103 provides track information, and the burst signal 104 is a signal that is used in controlling the transducer 16 to follow a center of the track 34, and includes, for example, four patterns such as A, B, C, and D. That is, a position error signal that is used to control track following is generated by combining four burst patterns.

A logic block address is allocated in a writable area of the disk 12. The logic block address of the disk drive is converted to cylinder/head/sector data to designate a writing area of the disk 12. The disk 12 is divided into a maintenance cylinder area, which a user cannot access, and a user data area, which the user can access. The maintenance cylinder area is also referred to as a system area. In the maintenance cylinder area, reallocation sector lists are stored. Also, in the disk 12, a spare sector that may replace defect sectors which may be generated in a user environment, are stored. For example, a predetermined number of spare sectors may be designated for each of the tracks 34 or zones. According to the present specification, a writable area including the user data area and the maintenance cylinder area of the disk 12 is referred to as a data area.

The transducer 16 is moved across the surface of the disk 12 to read or write data of other tracks. A plurality of code objects for implementing various functions in the disk drive may be stored in the disk 12. For example, a code object for performing a MP3 player function, a code object for executing a navigation function, or a code object for performing various video games may be stored in the disk 12.

Referring to FIG. 1, the processor 110 accesses the media 150 via the media interface 140 to write or read data. In detail, the media interface 140 in the data storage device that is implemented as a disk drive includes a servo circuit controlling the head disk assembly and a read/write channel circuit performing signal processing for reading/writing data.

The host interface 160 performs data transmission/reception to/from the host device 170 such as a personal computer, and may be an interface having various sizes, such as a serial advanced technology attachment (SATA) interface, a parallel advanced technology attachment (PATA) interface, or a universal serial bus (USB) interface.

The external interface 180 performs data transmission/reception to/from an external device via an input/output terminal installed in the data storage device. Examples of the external interface 80 include an accelerated graphics port (AGP) interface, a USB interface, a IEEE1394 interface, a personal computer memory card international Association (PCMCIA) interface, a local area network (LAN) interface, a Bluetooth interface, a high definition multimedia interface (HDMI), a programmable communication interface (PCI), an industry standard architecture (ISA) interface, a peripheral component interconnect-express (PCI-E) interface, an Express Card interface, a SATA interface, a PATA interface, or a serial interface.

The bus 190 transfers data between the elements of the data storage device.

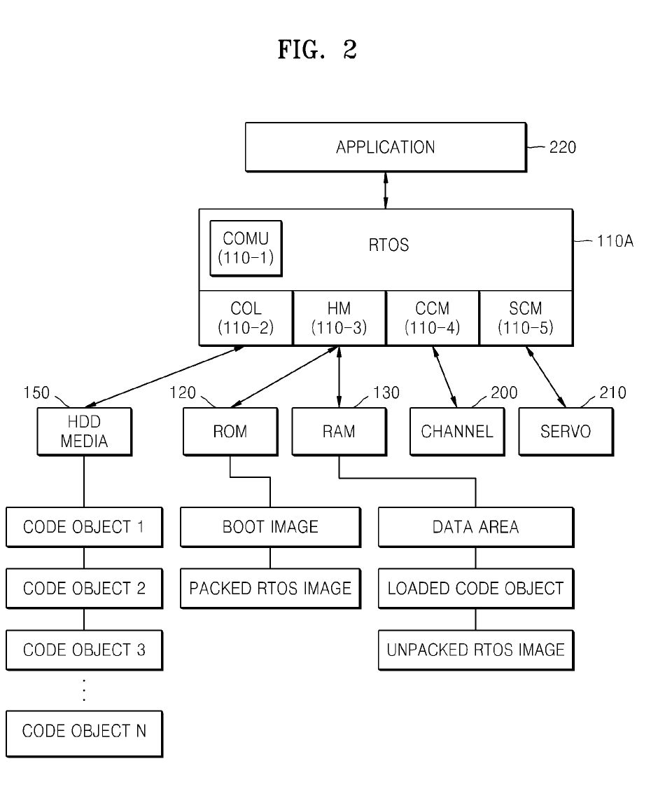

Next, a software operation system of a hard disk drive (HDD), which is an example of the data storage device, will be described with reference to FIG. 2.

FIG. 2 illustrates a software operation system of the data storage device of FIG. 1. Referring to FIG. 2, a plurality of code objects 1 through N are stored in the media 150 of the HDD.

In the ROM 120, a boot image and packed real time operating system (RTOS) image are stored.

In detail, the plurality of code objects 1-N are stored in the media 150 of the HDD, that is, a disk. The code objects stored in the disk may include not only code objects required for operating the disk drive but also code objects related to various functions that may be extended to the disk drive. In particular, code objects for executing the method of unloading the transducer in the data storage device according to the current embodiment of the inventive concept illustrated in FIGS. 14 and 15 are also stored in the disk. Obviously, the code objects for executing the methods illustrated in the flowcharts of FIGS. 14 and 15 may also be stored in the ROM 120 instead of the disk, which is the media 150 of the HDD. Also, code objects performing various functions such as a MP3 player function, a navigation function, a video game function, or the like may also be stored in the disk.

During booting, the boot image is read from the ROM 120 and an unpacked RTOS image is loaded to the RAM 130. Then, code objects required for executing a host interface or an external interface stored in the media 150 of the HDD is loaded to the RAM 130. Obviously, a data area for storing data is also allocated in the RAM 130.

Circuits that are required to perform signal processing for data reading/writing are included in a channel circuit 200, and circuits required for controlling a head disk assembly for performing data reading/writing are included in the servo circuit 210.

A RTOS 110A is a multiple program operating system using a disk. Depending on tasks, real-time multi-processing is performed at a high priority foreground, and batch-processing is performed at a low priority background. Then, loading of code object to the disk and unloading of the code objects to the disk are performed.

The RTOS 110A controls a code object management unit (COMU) 110-1, a code object loader (COL) 110-2, a memory handler (MH) 110-3, a channel control module (CCM) 110-4, and a servo control module (SCM) 110-5 to execute tasks according to requested commands. Also, the RTOS 110A controls application programs 220.

In detail, the RTOS 110A loads code objects required for controlling the disk drive to the RAM 130 when booting the disk drive. Accordingly, after the booting is executed, the disk drive may be operated by using code objects loaded to the RAM 130.

The COMU 110-1 stores position information about where code objects are written, converts virtual addresses into actual addresses, and performs bus arbitration. Also, information about priorities of tasks being executed is stored in the COMU 110-1. Also, the COMU 110-1 controls task control block (TCB) information and stack information required for executing tasks regarding code objects.

The COL 110-2 loads the code objects stored in the media 150 of the HDD to the RAM 130 by using the COMU 110-1 or unloads the code objects stored in the RAM 130 to the media 150 of the HDD. Accordingly, the COL 110-2 may load code objects for executing the methods of unloading a transducer in a data storage device according to the flowcharts illustrated in FIGS. 14 and 15 that are stored in the media 150 of the HDD, to the RAM 130.

Thus, the RTOS 110A may execute the methods of unloading a transducer in a data storage device according to the flowcharts illustrated in FIGS. 14 and 15, which will be described below, by using the code objects loaded in the RAM 130.

The MH 110-3 performs writing or reading data to/from the ROM 120 and the RAM 130.

The CCM 110-4 performs channel controlling required for performing signal processing for data reading/writing, and the SCM 110-5 performs servo controlling including the head disk assembly for performing data reading/writing.

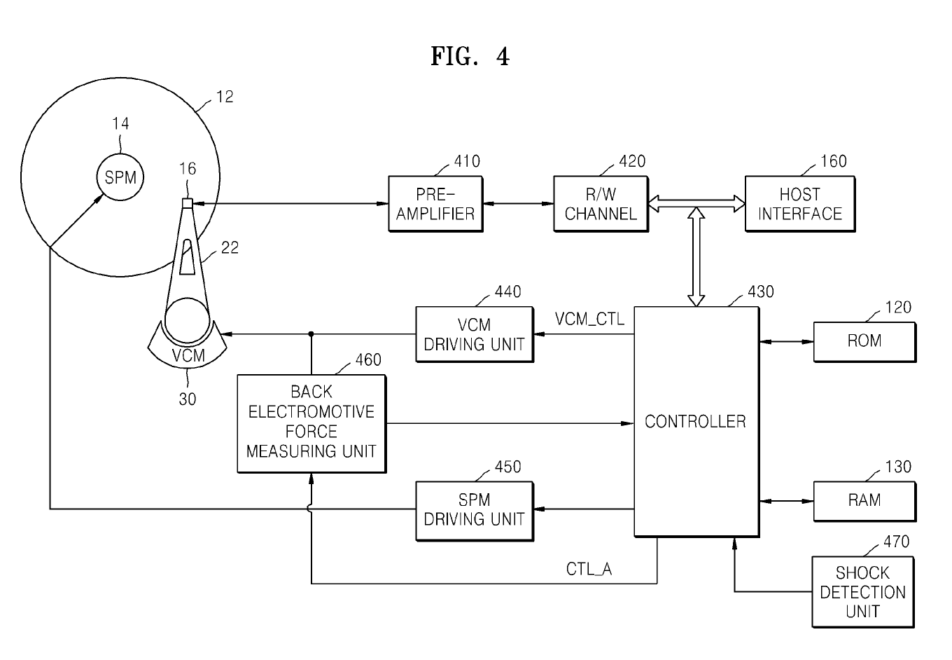

FIG. 4 illustrates an electric configuration of a disk drive, which is an example of the data storage device of FIG. 1.

As illustrated in FIG. 4, the disk drive according to the current embodiment of the inventive concept includes a pre-amplifier 410, a read/write (R/W) channel 420, a controller 430, a voice coil motor (VCM) driving unit 440, a spindle motor (SPM) driving unit 450, a back electromotive force measuring unit 460, a shock detection unit 470, a ROM 120, a RAM 130, and a host interface 160.

The shock detection unit 470 detects an amount of shock applied to the disk drive by using a sensor such as a piezoelectric sensor or an acceleration sensor and outputs shock amount information to the controller 430.

The controller 430 may be a digital signal processor (DSP), a microprocessor, a microcontroller, a processor, or the like. The controller 430 controls the R/W channel 420 to read data from the disk 12 or to write data to the disk 12 via the host interface circuit 160 according to a command received from the host device 170.

The controller 430 is coupled to the VCM driving unit 440 that supplies a driving current for driving a VCM 30. The controller 430 supplies a control signal to the VCM driving unit 440 to control movement of the transducer 16.

Also, the controller 430 is coupled to the SPM driving unit 450 that supplies a driving current for driving a spindle motor (SPM) 14. When power is supplied, the controller 430 supplies a control signal to the SPM driving unit 450 to rotate the SPM 14 at a target speed.

The controller 430 is coupled to the ROM 120 and the RAM 130. In the ROM 120, firmware and control data for controlling the disk drive are stored. Also, program codes and data for executing the method of unloading a transducer in a data storage device illustrated in FIGS. 14 and 15 according to the embodiments of the inventive concept are stored in the ROM 120. However, the program codes and data for executing the methods of unloading a transducer in a data storage device illustrated in FIGS. 14 and 15 according to the embodiments of the inventive concept may also be stored in a maintenance cylinder area of the disk 12 instead of in the ROM 120.

The controller 430 may control a moving speed of the transducer 16 by using a back electromotive force value of the VCM 30, which is measured by the back electromotive force measuring unit 460 when loading or unloading the transducer 16.

The back electromotive force measuring unit 460 detects back electromotive force generated in the VCM 30. FIG. 6 is a detailed circuit diagram of the back electromotive force measuring unit 460.

In FIG. 6, Rm denotes coil resistance of the VCM 30, Lm denotes coil inductance of the VCM 30, and Rs denotes sensing resistance for detecting a current Im flowing through the VCM 30. A variable gain amplifier AMPI amplifies a voltage that drops due to sensing resistance Rs, to a gain (A) that is variably controlled by the controller 430.

A voltage Vvcm applied to the VCM 30 is represented as in Equation 1 below.

Vvcm=Lm×dlm/dt+Rm×Im+Vbemf, [Equation 1]

where Vbemf denotes a voltage due to a back electromotive force of the VCM 30.

Accordingly, an output voltage Vo of the back electromotive force measuring unit 460 is represented as in Equation 2 below.

Vo=(Lm×dlm/dt+Rm×Im+Vbemf)−A×Rs×Im [Equation 2]

Assuming that the current Im through the VCM 30 at a point of time of measuring the back electromotive force is uniform, Equation 2 is represented as Equation 3 below.

$$\begin{matrix}Vo = Rm \times Im + Vbemf - A \times Rs \times Im \\ = Vbemf + ( Rm / Rs - A ) \times Im \times Rs\end{matrix} \qquad [ Equation 3 ]$$

Referring to Equation 3, while satisfying a condition of Rm/Rs−A=0, the output voltage Vo of the back electromotive force measuring unit 460 is equal to the back electromotive force voltage Vbemf that is generated by the VCM 30.

Accordingly, as Rs is already known, a back electromotive force value may be measured exactly by finding a Rm value and matching a gain (A) of the variable gain amplifier AMPI to Rm/Rs.

If the gain (A) of the variable gain amplifier AMPI is not consistent with Rm/Rs, there is an error in the back electromotive force value of the VCM 30 that is measured by the back electromotive force measuring unit 460. Meanwhile, coil resistance Rm of the VCM 30 varies according to temperature.

Accordingly, the controller 430 may control the disk drive so as to calibrate parameters used in measuring the back electromotive force after the transducer 16 is completely unloaded in the parking area.

In detail, when the transducer 16 is parked on the ramp parking unit 38, a VCM driving control signal for moving the transducer 16 toward the outer circumference of the disk 12 is generated. Then, the actuator arm 24 contacts the outer circumference crash stop rubber 37 and thus the transducer 16 is actually not moved, and thus a back electromotive force of the VCM 30 needs to be 0.

If the back electromotive force measured by the back electromotive force measuring unit 460 is not 0, it corresponds to an error in measurement of the back electromotive force. Accordingly, if the measurement error of the back electromotive force exceeds a critical range, the controller 430 performs back electromotive force calibration.

That is, when an absolute value |Vo| of a back electromotive force measurement value that is input by the back electromotive measurement unit 460 is greater than a critical value Vth, the controller 430 adjusts a parameter related to measurement of the back electromotive force such that the back electromotive force error is reduced. For example, the parameter related to the measurement of the back electromotive force may be a parameter that varies a gain (A) of the variable gain amplifier AMP1 of the circuit illustrated in FIG. 6.

The controller 430 adjusts the parameter related to the measurement of the back electromotive force as follows. If the back electromotive force measurement value Vo has a positive (+) value and exceeds a critical value, it can be seen that Rm/Rs>A as represented in Equation 3. Accordingly, the parameter is adjusted such that the amplitude of the gain (A) of the variable gain amplifier AMP1 is increased so as to reduce the error in the measurement of the back electromotive force.

On the other hand, when the back electromotive force measurement value Vo has a negative (−) value and exceeds a critical value, it can be seen that Rm/Rs<A as represented in Equation 3. Accordingly, the parameter is adjusted such that the amplitude of the gain (A) of the variable gain amplifier AMP1 is reduced so as to reduce the error in the measurement of the back electromotive force.

The amplitude of the gain (A) of the variable gain amplifier AMP1 according to the adjustment of the parameter may be designed so as to be varied stepwise, or the gain (A) may be designed so as to be varied in proportion to an amplitude that exceeds a critical range.

The controller 430 performs servo calibration that reduces a measurement error in the back electromotive force by using a control signal CTL_A that adjusts the gain (A) of the variable gain amplifier AMP1 in the above-described manner.

After applying the adjusted parameter by executing the back electromotive force calibration process, the controller 430 may control a loading speed or an unloading speed to a desired speed track while calculating a movement speed of a head according to the back electromotive force of a VCM, that is, a movement speed of an actuator.

In addition, the movement speed of the transducer 16 due to the back electromotive force of the VCM may be calculated as follows.

A relationship as given by Equation 4 is established between the back electromotive force voltage Vbemf of the VCM and an angle speed w of the VCM.

Vbemf=Kb×ω, [Equation 4]

where Kb is a back electromotive force constant.

Accordingly, the angle speed ω of the VCM 30 may be obtained from a back electromotive force measured at a point of time when an estimated speed of the transducer 16 is to be calculated. Since there is a proportional relationship between the angle speed of the VCM 30 and the actuator, a proportional constant Kc therebetween is already determined when designing the disk drive.

Accordingly, by multiplying the angle speed of the VCM 30 calculated from the measurement back electromotive force, with the proportional constant Kc, the movement speed of the transducer 16 due to the back electromotive force is finally calculated.

Next, typical data reading and writing operations of the disk drive will be described.

In a data read mode, the disk drive amplifies an electric signal that is sensed by the magnetic head 16 from the disk 12 in the pre-amplifier 410. Then, the R/W channel 420 amplifies the electrical signal output from the pre-amplifier 410 by using an automatic gain control circuit (not shown) that automatically varies a gain according to an amplitude of the electrical signal, converts the electrical signal into a digital signal, and then decodes the digital signal to detect data. For example, an error correction process may be performed on the detected data by the controller 430 by using a read Solomon code, and then the detected data may be converted into stream data and transmitted to the host device 170 via the host interface circuit 160.

Next, in a write mode, the disk drive receives data from the host device 170 via the host interface circuit 160, and the controller 430 adds an error correction parity symbol using a read Solomon code, and the R/W channel 420 encodes the data to be suitable for a writing channel, and then the data is written to the disk 12 via the magnetic head 16 by using a write current that is amplified by the pre-amplifier 410.

Next, the method of unloading a transducer in a data storage device, according to an embodiment of the inventive concept, which is executed in the disk drive, will be described in detail.

The controller 430 loads program codes and data for executing the methods of unloading the transducer in the data storage device stored in the ROM 120 or the disk 12 to the RAM 130, and controls the elements of the disk drive to execute the methods of unloading the transducer in the data storage device illustrated in FIGS. 14 and 15 using the program codes and data loaded to the RAM 130.

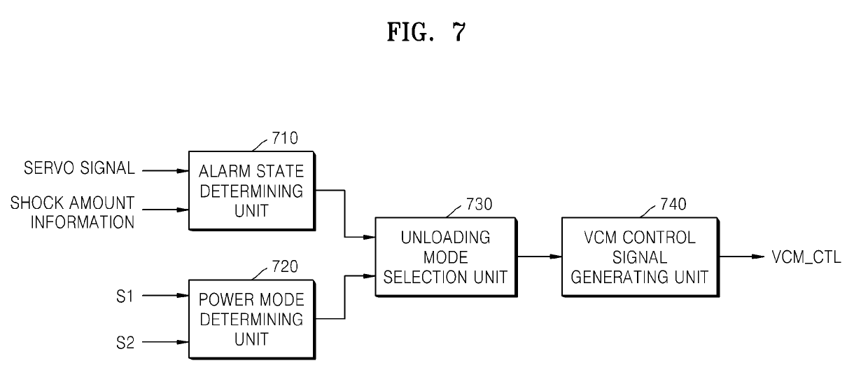

FIG. 7 is a circuit block diagram of a transducer unloading device in a data storage device according to an embodiment of the inventive concept. The transducer unloading device in the data storage device illustrated in FIG. 7 may be designed so as to be included in the processor 110 of the data storage device or the controller 430 of FIG. 4, or may be a separate circuit.

According to the current embodiment of the inventive concept, the transducer unloading device of the data storage device of FIG. 7 is designed so as to be included in the processor 110 or the controller 430.

Hereinafter, a transducer unloading device in a data storage device according to an embodiment of the inventive concept will be described.

As illustrated in FIG. 7, the transducer unloading device includes an alarm state determining unit 710, a power mode determining unit 720, an unloading mode selection unit 730, and a VCM control signal generating unit 740.

The alarm state determining unit 710 detects a state in which a disturbance that exceeds an allowable range of the disk drive occurs or a state in which the disk drive may not normally operate.

In detail, the alarm state determining unit 710 determines an alarm state based on shock amount information that is input by the shock detection unit 470 and a servo signal input from the read/write channel 420 while the transducer 16 is located on the data area on the disk.

The alarm state determining unit 710 may determine a case as an alarm state when shock amount information is greater than an impact critical value that may be allowed by the disk drive. Also, the alarm state determining unit 710 may determine a case as an alarm state when an error is detected from a servo signal read from the servo information field 801 of the disk 12. For example, when an error is detected from the gray code 103, it may be determined as an alarm state.

When impact amount information is greater than an impact critical value that may be allowed in the disk drive or an error is detected from a servo signal, the alarm state determining unit 710 outputs a first signal that informs that an alarm state has occurred.

When a first state signal SI that indicates that the disk drive is transitioned from a power on mode to a power off mode or a second state signal S2 that indicates that the disk drive is transitioned from the power on mode to a power save mode is input, the power mode determining unit 720 outputs a second signal that informs that an unloading operation is required due to the change in power mode. The power save mode refers to a mode in which a power supply to circuit blocks except the controller 430 is blocked for power saving in the disk drive if a new command is not input for a predetermined period of time after the disk drive transitions to a standby state.

The unloading mode selection unit 730 selects one of a plurality of unloading modes according to a first signal input from the alarm state determining unit 710 or a second signal input from the power mode determining unit 720.

The unloading mode selection unit 730 selects a disk inner unloading mode when a first signal is input from the alarm state determining unit 710, and when a second signal is input from the power mode determining unit 720, the unloading mode selection unit 730 generates unloading mode selection information for selecting a ramp unloading mode.

If the first signal and the second signal are input to the unloading mode selection unit 730 at the same time, the unloading mode selection unit 730 may be designed so as to generate unloading mode selection information for selecting a ramp unloading mode.

The VCM control signal generating unit 740 generates a VCM control signal that is appropriate for an unloading mode that is selected according to the unloading mode selection information generated by the unloading mode selection unit 730.

Referring to FIG. 4 again, a VCM control signal generated by the VCM control signal generating unit 740 is applied to the VCM driving unit 440. Then, the VCM driving unit 440 generates a current to be supplied to the VCM 30 according to a VCM control signal.

According to the above operation, the transducer unloading device parks the transducer in an inner circumferential area of the disk according to the disk inner unloading mode when a condition that requires an unloading condition exists based on an alarm state that indicates a case in which the disk drive cannot normally operate in the disk drive while the transducer 16 is positioned on the data area on the disk 12, and parks the transducer 16 on the ramp parking unit that is positioned on the outer circumferential area of the disk according to a ramp unloading mode under a condition that requires an unloading operation according to another power mode change.

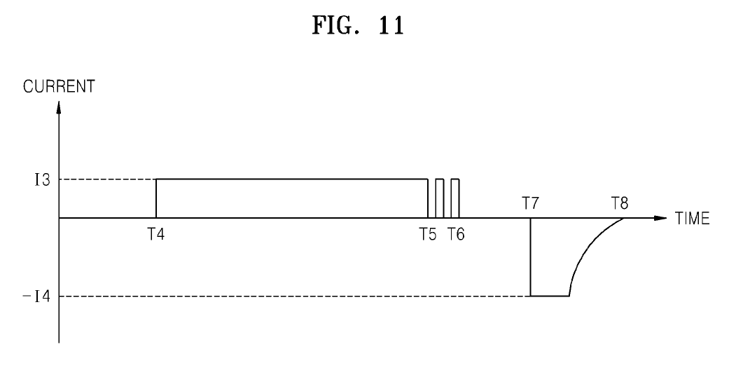

FIG. 10 illustrates a current waveform supplied to the VCM 30 in an unloading operation when the ramp unloading mode is applied, and FIG. 11 illustrates a current waveform supplied to the VCM 30 in a loading operation in which the transducer 16 is loaded to the data area of the disk 12 from the ramp parking unit 38.

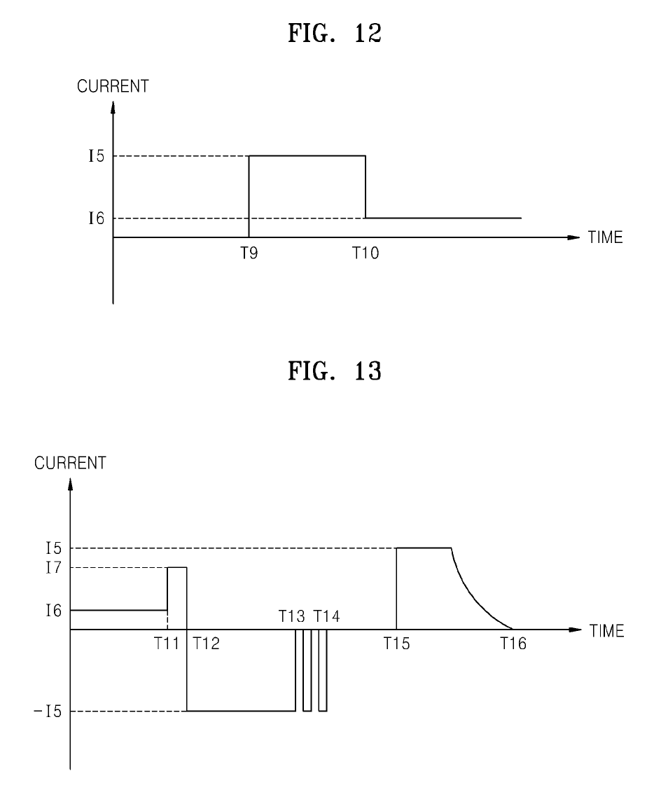

FIG. 12 illustrates a current waveform supplied to the VCM 30 in an unloading operation when a disk inner unloading mode is applied, and FIG. 13 illustrates a current waveform supplied to the VCM 30 in a loading operation in which the transducer 16 is loaded to the data area of the disk 12 from an inner circumferential parking area of the disk 12.

In FIGS. 10 through 13, when a polarity of a current supplied to the VCM 30 is positive (+), the VCM 30 moves an actuator toward the inner circumference of the disk 12. On the other hand, when a polarity of a current supplied to the VCM 30 is negative (−), the VCM 30 moves the actuator toward the outer circumference of the disk 12.

The ramp unloading mode needs to move at a relatively low speed in order to prevent instrumental damage of the head gimbal assembly 22 as the head gimbal assembly 22 goes up and down the ramp parking unit 38. When the transducer 16 is loaded or unloaded at a relatively high speed, a head suspension of the head gimbal assembly 22 may be damaged or a flying height of the transducer 16 may be reduced, and thus the transducer 16 and the disk 12 contact each other, and the transducer 16 may be damaged, thereby generating a permanent defect in the disk 12.

On the other hand, in the disk inner unloading mode, an unloading operation is performed by fixing the actuator arm 24 to the inner circumference crash stop rubber 36, and thus the head gimbal assembly 22 may be moved quickly compared to the ramp unloading mode, and thus it is less likely that instrumental damage during the unloading operation may be generated.

Referring to FIG. 10, when a ramp unloading mode is applied, an unloading mode starts at a time T1, and a current −I1 is applied to the VCM 30 from the time T1 to a time T2, and a current supplied to the VCM 30 from the time T2 to a time T3 is a current for verification, which is used to surely park the head gimbal assembly 22 to the ramp parking unit 38.

Referring to FIG. 11, a loading operation in which the transducer 16 is loaded to the data area of the disk 12 from the ramp parking unit 38 starts at a time T4, and a current I3 is applied to the VCM 30 from the time T4 to a time T5, and a pulse current for controlling a speed of the actuator by using a back electromotive force of the VCM 30 is applied at the time T5 to a time T6 to the VCM 30, and a negative (−) break current is applied to the VCM 30 from a time T7 to a time T8.

Referring to FIG. 12, an unloading operation in which the disk inner unloading mode is applied starts at a time T9, and from the time T9 to a time T10, a current I5 is applied to the VCM 30, and after the time T10, a current I6 is applied to the VCM 30. The current I6 applied after the time T10 is applied to fix the actuator arm 24 to the inner circumference crash stop rubber 36.

Referring to FIG. 13, a loading operation in which the transducer 16 is loaded to the data area of the disk 12 in a parking area of an inner circumference of the disk 12 starts at a time T11, and a current I7 is applied to the VCM 30 during a time T11-T12. The current I7 is a current for generating reaction toward the inner circumference of the disk 12 from the inner circumference crash stop rubber 36. During a time T12-T13, a current −I5 is applied to the VCM 30. During a time T13-T14, a pulse current for controlling a speed of an actuator is applied to the VCM 30 by using a back electromotive force of the VCM 30, and during a time T15-T16, a positive (+) break current is applied to the VCM 30.

Referring to FIGS. 10 through 13, the amplitude of the current −I1 that is applied to the VCM 30 in a ramp unloading mode is smaller than the amplitude of the current I5 that is applied to the VCM 30 in a disk inner unloading mode. Accordingly, an unloading speed of the ramp unloading method is slower than an unloading speed of the disk inner unloading mode. This causes the unloading time T1-T2 of the ramp unloading mode to be longer than the unloading time T9-T10 of the disk inner unloading mode.

Also, in order to load the transducer 16 from the ramp parking unit 38 to the data area of the disk 12, the amplitude of the current I3 that is applied to the VCM 30 is smaller than the amplitude of the current −I5 that is applied to the VCM 30 to load the transducer 16 from the inner parking area of the disk 12 to the data area of the disk 12. Accordingly, a loading speed in the ramp parking unit 38 is slower than a loading speed in the disk inner circumference parking area. Consequently, this causes the loading time T4-T8 taken by the ramp parking unit 38 to be longer than the loading time T11-T16 in the disk inner parking area.

The processor 110 or the controller 430 parks the transducer 16 in the inner circumference area of the disk 12 according to a disk inner unloading mode when an alarm state is generated by the transducer unloading device as illustrated in FIG. 7, and initializes processes and parameters of the data storage device, and sequentially performs loading processes for moving the transducer 16 to the data area on the disk 12.

That is, after performing an unloading process according to an alarm state, the processor 110 or the controller 430 initializes channel parameters to setup values of channel parameters of the data storage device loaded to the RAM 130, and controls the data storage device to perform calibration of a mechanical/electrical unit. For example, the calibration of the instrumental/electrical unit may include back electromotive force calibration as described above. After initializing the above-described parameters, the processor 110 or the controller 430 generates a VCM control signal for executing a loading process that moves the transducer 16 to the data area of the disk 12.

Next, a method of unloading a transducer in the data storage device according to the controlling of the processor 110 of the data storage device of FIG. 1 or the controller 430 of the disk drive according to an embodiment of the present general inventive concept will be described with reference to FIGS. 14 and 15. Here, controlling by the controller 430 will be described for convenience of description, but the present general inventive concept is not limited thereto.

First, a method of unloading a transducer 16 in a data storage device according to an embodiment of the present general inventive concept will be described with reference to FIG. 14.

In operation S101, when a signal that indicates a transition of the disk drive from a power off mode to a power on mode is input, the controller 430 controls such that power is supplied to each unit of the disk drive.

In operation S102, the controller 430 controls the spindle motor 14 to be driven after completing the power supply according to the power on mode. That is, a spindle motor SPM control signal is generated by the controller 430 and is applied to the SPM driving unit 450, and then the SPM driving unit 450 generates a current for driving the spindle motor and supplies the current to the spindle motor 14. Accordingly, the spindle motor 14 starts to rotate. For example, the controller 430 controls the spindle motor 14 to be driven in an open loop according to a driving current that is initially set until a reliable back electromotive force is detected in the spindle motor 14. After detecting a reliable back electromotive force in the spindle motor 14, the controller 430 may estimate a speed of the spindle motor 14 by using the detected back electromotive force, and thus controls the spindle motor to be driven in a closed loop to reach a target speed based on the estimated speed.

After driving the spindle motor 14, the controller 430 controls the disk drive to perform a loading operation of the transducer 16 in operation S103. When the ramp parking unit 38 is set to the disk drive, the transducer 16 is parked on the ramp parking unit 38 in a power off mode. Accordingly, the controller 430 generates a VCM control signal for moving the transducer 16 to the data area of the disk 12 from the ramp parking unit 38. Then the VCM driving unit 440 generates a current as illustrated in FIG. 11 according to a VCM control signal and applies the current to the VCM 30. As the actuator rotates according to the current applied to the VCM 30, the transducer 16 is moved to the data area of the disk 12.

After performing a loading operation of moving the transducer 16 to the data area of the disk 12, the controller 430 determines whether an unloading condition is generated in the disk drive in operation S104. The unloading condition is generated when an alarm state showing a state in which the disk drive cannot operate normally, or the disk drive is transitioned from a power on mode to a power off mode, or when the disk drive is transitioned from a power on mode to a power save mode. For example, the state in which the disk drive cannot normally operate may be when shock beyond the allowable range is generated in the disk drive or when an error is detected from a servo signal.

When an unloading condition is not generated as a result of the determination of operation S104, the controller 430 controls the disk drive to execute a command given by the host device in operation S105. That is, the controller 430 performs a reading or writing operation according to a command given by the host device or stays on standby if a new command is not received after executing the given command.

When an unloading condition is generated as a result of the determination of operation S104, one of a plurality of unloading modes is selected according to the generated unloading condition in operation S106. When the unloading condition is generated based on the alarm state which indicates a state in which the disk drive cannot normally operate, the controller 430 selects a disk inner unloading mode. When an unloading condition is generated as the disk drive transitions from a power on mode to a power off mode or the disk drive transitions from a power on mode to a power save mode, the controller 430 selects a ramp unloading mode.

Next, in operation S107, the controller 430 controls the disk drive so as to perform an unloading operation according to a selected unloading mode. When a disk inner unloading mode is selected in operation S106, the controller 430 generates a VCM control signal for moving the transducer 16 which is disposed on the data area on the disk 12 to a parking area positioned in an inner circumference area of the disk 12. Accordingly, as a current as illustrated in FIG. 12 is applied to the VCM 30 to rotate the actuator, the transducer 16 is moved to a parking area positioned in the inner circumferential area on the disk 12. When a ramp unloading mode is selected in operation S106, the controller 430 generates a VCM control signal for moving the transducer 16 to the ramp parking unit 38 positioned in an outer circumferential area of the disk 12. Accordingly, as a current as illustrated in FIG. 10 is applied to the VCM 30 to rotate the actuator, the transducer 16 is moved to the ramp parking unit 38.

Next, a method of unloading a transducer in a data storage device according to another embodiment of the present general inventive concept will be described with reference to FIG. 15.

Operations S201 through S203 of FIG. 15 are the same as the operations S101 through S103 illustrated in FIG. 14, and thus descriptions thereof will not be repeated here.

After performing operations S201 through S203, the controller 430 determines whether an alarm state is generated in a disk drive in operation S204. An alarm state is generated when the disk drive cannot normally operate, for example, when a shock beyond an allowable range is detected in the disk drive or an error is detected from a servo signal.

When an alarm state is generated in the disk drive as a result of the determination of operation S204, the controller selects a disk inner unloading mode from among a plurality of unloading modes, and controls the disk drive to perform the selected disk inner unloading mode in operation S205. In detail, the controller 430 generates a VCM control signal for moving the transducer 16 positioned in the data area on the disk 12 to a parking area positioned in an inner circumference area of the disk 12. Thus, the VCM 30 rotates the actuator so as to move the transducer 16 to a parking area positioned in an inner circumferential area on the disk 12. That is, the controller 430 generates a VCM control signal such that a current as illustrated in FIG. 12 is applied to the VCM 30, thereby parking the transducer 16 by fixing the actuator arm 24, to which the transducer 16 is attached, to the inner circumference crash stop rubber 36.

After operation S205, the controller 430 performs an operation of initializing channel parameters in operation S206. The initialized channel parameters may include parameters for determining a gain of various filters used in data processing in a read channel or a write channel and parameters for determining frequency characteristics. In detail, the controller 430 may initialize channel parameters to setup values of channel parameters of the disk drive loaded to the RAM 130.

After performing operation S206, the controller 430 performs a servo calibration in operation S207. The servo calibration may include a back electromotive force calibration. The detailed process of performing the back electromotive calibration has been described above, and thus description thereof will not be repeated.

After the operation S207, the controller 430 controls the disk drive to perform a loading operation of moving the transducer 16 fixed to an inner circumference parking area of the disk 12 to the data area on the disk 12 in operation S208. In detail, the controller 430 generates a VCM control signal for moving the transducer 16, which is fixed to the inner parking area on the disk 12, to the data area on the disk 12. Thus, the VCM 30 rotates an actuator to thereby move the transducer 16 onto the data area on the disk 12. That is, the controller 430 generates a VCM control signal such that a current as illustrated in FIG. 13 is applied to the VCM 30, and the transducer 16 is moved to the area of the disk 12 accordingly.

When an alarm state is not generated in the disk drive after a result of operation S204 or after performing operation S208, the controller 430 determines whether the disk drive transitions from a power on mode to a power off mode or to a power save mode in operation S209.

As a result of the determination of operation S209, when the disk drive does not transition from the power off mode or to the power save mode, the controller 430 controls the disk drive to execute a command that is given by a host device in operation S210. That is, the controller 430 performs a reading operation or a writing operation according to a command given by the host device or maintains a standby state when a new command is not received after executing the given command.

When the disk drive is transitioned from a power off mode or to a power save mode as a result of the determination of operation S209, the controller 430 selects a ramp unloading mode from among a plurality of unloading modes, and controls the disk drive to perform the selected ramp unloading method in operation S211. In detail, the controller 430 generates a VCM control signal to move the transducer 16 from the data area on the disk 12 to the ramp parking unit 38 that is positioned on an outer circumferential area of the disk 12. Accordingly, the VCM 30 rotates an actuator to thereby move the transducer 16 to the ramp parking unit 38. That is, the controller 430 generates a VCM control signal such that a current as illustrated in FIG. 10 is applied to the VCM 30 to move the transducer 16 to the ramp parking unit 38, and parks the transducer 16 by fixing the actuator arm 24, to which the transducer 16 is attached, to the outer circumference crash stop rubber 37.

According to the above operation, one unloading mode is selected from among a plurality of unloading modes according to conditions that require unloading of the transducer in the disk drive and executed. The plurality of unloading modes may include a ramp unloading mode and a disk inner unloading mode as described above.

The ramp unloading mode is advantageous in view of stability in that instrumental damage due to disturbance after parking may be prevented compared to the disk inner unloading method. However, in the ramp unloading mode, instrumental damage may occur due to contact between the ramp parking unit 38 and the head gimbal assembly 22 during an unloading operation compared to the disk inner unloading mode, and since the ramp unloading mode is frequently performed, the lifespan of the disk drive may be reduced, and loading and unloading times are relatively long.

On the other hand, when using the disk inner unloading mode, instrumental damage may occur less frequently during the loading operation compared to the ramp unloading mode, and loading and unloading times are shorter. However, the durability of the disk drive in regard to preventing instrumental damage due to disturbances after the parking may be poor.

According to the embodiments of the present general inventive concept, an optimum unloading mode is selected according to circumstances in which unloading of the transducer is required, in consideration of the advantages and disadvantages of the ramp unloading mode and the disk inner unloading mode to perform unloading of the transducer.

That is, under a condition that requires an unloading operation based on an alarm state of the disk that maintains parking for a relatively short time, a disk inner unloading mode is selected to unload the transducer, thereby quickly performing the unloading.

Also, when an unloading operation is required due to a power mode change that maintains parking for a relatively long time, the ramp unloading mode is selected to unload the transducer, thereby effectively preventing instrumental damage of the disk drive after parking.

The inventive concept may be executed as a method, a device, a system, or the like. When the method is executed as software, elements of the inventive concept are code segments executing operations that are necessarily required. Programs or code segments may be stored in a processor readable medium.

While the inventive concept has been particularly shown and described with reference to exemplary embodiments thereof, the exemplary embodiments should be considered in a descriptive sense only, and not for purposes of limitation. Thus, it will be understood by those of ordinary skill in the art that various changes in form and details may be therein without departing from the spirit and scope of the inventive concept as defined by the appended claims. Therefore, the scope of the inventive concept is defined not by the detailed description of the inventive concept but by the appended claims, and all differences within the scope will be construed as being included in the inventive concept.

What is claimed is:

1. A method of unloading a transducer in a data storage device, the method comprising:
determining whether a condition that requires an unloading operation while a transducer is positioned on a data area on a disk is detected;
selecting, when the condition that requires the unloading operation is detected, an unloading mode corresponding to the detected condition from among a plurality of unloading modes; and
moving the transducer to an area other than the data area on the disk according to the selected unloading method.

2. The method of claim 1, wherein the plurality of unloading modes include a ramp unloading mode in which the transducer is parked at the ramp parking unit and a disk inner unloading mode in which the transducer is parked in an inner circumferential area of the disk.

3. The method of claim 2, wherein in the disk inner unloading mode, an actuator arm in which the transducer is mounted is controlled to be fixed to an inner circumference crash stop rubber to park the transducer in an inner circumferential area of the disk.

4. The method of claim 1, wherein in the selecting of an unloading mode, a disk inner unloading mode of parking the transducer in the inner circumferential area of the disk is selected when a condition that requires an unloading operation is detected based on an alarm state that indicates that the data storage device cannot normally operate, and a ramp unloading mode of parking the transducer in the ramp parking unit is selected when other unloading operations are required.

5. The method of claim 4, wherein the alarm state is determined when a disturbance sensed by the data storage device exceeds a critical value or when a servo signal written to the disk is not normally read.

6. The method of claim 4, wherein the ramp unloading mode is selected under a condition when the disk drive transitions from a power on mode to a power off mode or to a power save mode.

7. The method of claim 1, wherein when the disk inner unloading mode is selected from among the plurality of unloading modes, an actuator arm, to which the transducer is attached, is moved to the inner circumference crash stop rubber, and then a predetermined force is applied to the actuator arm toward the inner circumference crash stop rubber.

8. The method of claim 1, wherein when the selected unloading mode is a disk inner unloading mode based on an alarm state, the method further comprises initializing parameters of the data storage device and moving the transducer to the data area on the disk after moving the transducer toward the inner circumference so that the transducer is parked in the inner circumferential area other than the data area of the disk.

9. The method of claim 8, wherein the initializing of the parameters comprises calibration of an instrumental/electrical unit with respect to channel parameters of the data storage device.

10. The method of claim 8, wherein the moving the transducer comprises controlling a movement speed of the transducer using a back electromotive force.

11. A disk drive comprising:
a disk storing data;
a transducer that writes to the disk or reads data from the disk;
a voice coil motor (VCM) moving the transducer; and
a controller that selects, when a condition that requires an unloading operation is detected while the transducer is positioned in a data area on the disk, an unloading mode corresponding to the detected condition, from among a plurality of unloading modes and controls a current supplied to the VCM so as to execute an unloading process.

12. The disk drive of claim 11, wherein the plurality of unloading modes include a ramp unloading mode of parking a transducer in a ramp parking unit positioned in an outer circumferential area of a disk and a disk inner unloading mode of parking the transducer in a parking area positioned in an inner circumferential area of the disk.

13. The disk drive of claim 11, wherein the controller detects a movement speed of the transducer by using a back electromotive force that is generated in the VCM in a loading operation or an unloading operation, and controls a current supplied to the VCM such that the detected movement speed of the transducer reaches a target speed.

14. The disk drive of claim 11, wherein the controller controls a current supplied to the VCM such that an actuator arm, to which the transducer is mounted, is fixed to an inner circumference crash stop rubber installed in a head disk assembly, when a disk inner unloading mode is selected from among a plurality of unloading modes.

15. The disk drive of claim 11, wherein the controller executes a disk inner unloading mode for parking the transducer in an inner circumferential area of the disk when a condition that requires an unloading operation is detected based on an alarm state that indicates that the disk drive cannot normally operate, and controls a current supplied to the VCM so as to execute a ramp unloading mode for parking the transducer in the ramp parking unit under other conditions that require an unloading operation.

16. The disk drive of claim 15, wherein when a shock amount sensed by the data storage device exceeds a critical value or a servo signal written to the disk cannot be normally read, the controller determines that the alarm state is generated.

17. The disk drive of claim 11, wherein the controller controls initializing of channel parameters and performing of calibration of an instrumental/electrical unit after executing an unloading process by selecting a disk inner unloading mode based on a generated alarm state.

18. The disk drive of claim 17, wherein after initializing the channel parameters and performing calibration of an instrumental/electrical unit, the controller controls a current supplied to the VCM so as to move the transducer to a data area on the disk.

19. The disk drive of claim 11, wherein after performing a disk inner unloading process the controller supplies a current for moving the transducer toward an inner circumference of the disk for a predetermined period of time to the VCM at a timing for executing a loading process, and the controller supplies a current for moving the transducer toward an outer circumference of the disk to thereby move the transducer to the data area on the disk.

20. A computer readable storage medium having embodied thereon a program code for executing a method comprising:
determining whether a condition that requires an unloading operation is detected while a transducer is positioned on a data area on a disk;
selecting, when the condition that requires the unloading operation is detected, an unloading mode corresponding to the detected condition from among a plurality of unloading modes; and
moving the transducer to an area other than the data area on the disk according to the selected unloading mode.
